(19) United States
(12) Patent Application Publication
(10) Pub. No.: US 2011/0142201 A1
(43) Pub. Date: Jun. 16, 2011

(54) MULTI-VIEW IMAGING SYSTEM AND METHOD

(75) Inventors: Jeffrey Wayne Eberhard, Albany, NY (US); Bernhard Erich Hermann Claus, Niskayuna, NY (US); Colin Richard Wilson, Niskayuna, NY (US); Kedar Bhalchandra Khare, Niskayuna, NY (US)

(73) Assignee: GENERAL ELECTRIC COMPANY, SCHENECTADY, NY (US)

(21) Appl. No.: 12/638,471

(22) Filed: Dec. 15, 2009

(51) Int. Cl. G01N 23/04

(52) U.S. Cl. 378/57

(57) ABSTRACT

A multi-view imaging system and method is disclosed. The system comprises: multiple X-ray sources emitting X-rays in a fan-shaped beam each having a first and a second beam edge defining a fan beam angle located in a predetermined configuration around an imaging volume; a system controller configured to operate the X-ray sources; detectors, to detect X-rays and configured to generate signals in response to the detected X-rays, wherein each of the plurality of X-ray sources are configured to emit X-rays to one or more detectors, further wherein the X-ray source and two end points of a corresponding detector define a fan beam plane, further wherein a line extending from the X-ray source within the fan beam plane and through the imaging volume defines a projection direction, wherein adjacent projection directions define an angular spacing; an object conveyance device configured for transporting an object along a path of travel through the imaging volume between the X-ray sources and the detectors; and a detector interface configured to acquire the signals from the detectors, wherein the predetermined configuration is defined wherein either: the projection directions when viewed along a longitudinal axis of the image system surround the imaging volume by an angular range of about 180 degrees; or the projection directions when viewed along a longitudinal axis of the image system surround the imaging volume by an angular range of about 180°−180/Q, wherein Q is a quantity of the projection directions.

### BACKGROUND OF THE INVENTION

The present invention relates generally to X-ray imaging systems, often used in security applications, and more particularly to a multi-view imaging system and method.

One imaging methodology that may be employed in current security applications is to have one or two X-ray beam lines, operating in conventional projection imaging fashion, scanning objects. Another imaging methodology that may be used, at least theoretically, is to employ a Computed Tomography (CT) system with a fully rotating gantry that generates hundreds, if not thousands, of images of the scanned objects. Conceptually, these two methodologies could be thought of as being at two opposing ends of the technical “spectrum” for X-ray imaging systems.

Both ends of this spectrum have their advantages and disadvantages. Whereas the single, or dual, beam line conventional tomography system offers a simpler and less expensive system, the limited quantity of image views generated is less than optimal in accurately detecting contraband. Contrastingly, the full CT system, in generating a very large quantity of views, is able to offer much more accurate detection capability, but at a significantly higher cost.

Paramount with any effective security system is a high probability of detection coupled with a low false alarm rate. However, there are other issues that factor into the overall efficacy of security systems including, for example, both the initial and the running cost of the system, throughput speed, system footprint, ease of use, and the like. Neither of the aforementioned imaging systems adequately address and balance enough of these issues.

Accordingly, there is an ongoing need for improving upon existing X-ray imaging systems that more effectively balance some of these issues.

### BRIEF DESCRIPTION

In accordance with an embodiment of the invention, a multi-view imaging system, comprises: a plurality of X-ray sources, each X-ray source configured to emit X-rays, wherein each X-ray source emits X-rays in a fan-shaped beam each having a first and a second beam edge defining a fan beam angle, wherein the plurality of X-ray sources are located in a predetermined configuration around an imaging volume; a system controller configured to operate the plurality of X-ray sources; a plurality of detectors, each detector configured to detect X-rays, each detector configured to generate signals in response to the detected X-rays, wherein each of the plurality of X-ray sources are configured to emit X-rays to at least one of the plurality of detectors, further wherein the X-ray source and two end points of a corresponding detector define a fan beam plane, further wherein a line extending from the X-ray source within the fan beam plane and through the imaging volume defines a projection direction, wherein adjacent projection directions define an angular spacing; an object conveyance device configured for transporting an object along a path of travel through the imaging volume between the plurality of X-ray sources and the plurality of detectors; and a detector interface configured to acquire the signals from the plurality of detectors, wherein the predetermined configuration is defined wherein one of: the plurality of projection directions when viewed along a longitudinal axis of the image system surround the imaging volume by an angular range of about 180 degrees; and the plurality of projection directions when viewed along a longitudinal axis of the image system surround the imaging volume by an angular range of about 180°−180/Q, wherein Q is a quantity of the plurality of projection directions.

In accordance with another embodiment of the invention, a multi-view imaging system, comprises: a plurality of X-ray sources, each X-ray source configured to emit X-rays in a fan-shaped beam having a first and a second beam edge defining a fan beam angle, wherein the plurality of X-ray sources are located in a predetermined pattern around an imaging volume; a system controller configured to operate the plurality of X-ray sources; a plurality of detectors, each configured to detect X-rays emitted by at least one of the plurality of X-ray sources and to generate signals in response to the detected X-rays, wherein an X-ray source and two end points of a corresponding detector define a fan beam plane, further wherein a line extending from the X-ray source through the fan beam plane defines a projection direction, wherein adjacent projection direction define an angular spacing; an object conveyance device configured for transporting an object along a path of travel through the imaging area between the plurality of X-ray sources and the plurality of detectors; and a detector interface configured to acquire the signals from the plurality of detectors, wherein the predetermined pattern is defined wherein one of: the plurality of projection directions surround the imaging volume by an angular range of about 180 degrees, and the plurality of projection directions surround the imaging volume by an angular range of about 180°−180/Q, wherein Q is a quantity of the plurality of projection directions.

These and other advantages and features will be more readily understood from the following detailed description of preferred embodiments of the invention that is provided in connection with the accompanying drawings.

### BRIEF DESCRIPTION OF THE DRAWINGS

The foregoing and other advantages and features of the invention will become apparent upon reading the following detailed description and upon reference to the drawings in which:

FIG. 1 is a block diagram depicting an exemplary multi-view imaging system, in accordance with an aspect of the present invention;

FIG. 2A is a view of a portion (single source and a corresponding single detector) of an exemplary multi-view imaging system, in accordance with an aspect of the present invention;

FIG. 2B is a view of a portion (two sources and their corresponding two detectors) of an exemplary multi-view imaging system, in accordance with an aspect of the present invention;

FIG. 3 is perspective view of a portion of an exemplary multi-view imaging system, in accordance with an aspect of the present invention;

FIGS. 4A-4C depict top views of portions of an exemplary multi-view imaging system, in accordance with an aspect of the present invention;

FIGS. 5A-5D depict end views of portions of an exemplary multi-view imaging system, in accordance with an aspect of the present invention;

FIG. 6 is a plan view of an exemplary multi-view imaging system, in accordance with an aspect of the present invention;

FIGS. 7A-7C depict various detector embodiments used in exemplary multi-view imaging systems, in accordance with an aspect of the present invention;

FIG. 8 depicts a side perspective view of an exemplary multi-view imaging system, in accordance with an aspect of the present invention;

FIG. 9 depicts an end view of an exemplary multi-view imaging system, in accordance with an aspect of the present invention;

FIG. 10 depicts an end view of an exemplary multi-view imaging system, in accordance with an aspect of the present invention;

FIG. 11 depicts an end view of an exemplary multi-view imaging system, in accordance with an aspect of the present invention;

FIG. 12 depicts a plan view of an exemplary multi-view imaging system, in accordance with an aspect of the present invention;

FIG. 13 depicts a plan view of an exemplary multi-view imaging system, in accordance with an aspect of the present invention; and

FIG. 14 is a flow chart depicting an exemplary multi-view imaging method, in accordance with an aspect of the present invention.

### DETAILED DESCRIPTION

As discussed in detail below, embodiments of the invention include a multi-view imaging system and method.

The present technique is generally directed to the use of imaging techniques to generate more useful images, such as for inspection or other security or non-security (e.g., medical) applications. In general, tomo synthesis imaging techniques allow for the reconstruction of a volumetric data set from an incomplete set of projection images, i.e., insufficient projection images to fill Radon space. In the context of the present technique, multiple projection images may be acquired at different orientations relative to an imaged object, such as an article of luggage. The projection images may then be processed to generate a volumetric dataset, which may be used for the, analysis, visualization and display of selected volumes of image data. In a security context the image data may provide information, such as three-dimensional context, that is unavailable in standard security inspection checkpoints. In an embodiment, the image data obtained may enhance the ability to detect sheet-type goods, which can be useful in the security context. As will be appreciated by those of ordinary skill in the art, the present techniques may also be applied in other security and non-security contexts, such as for medical examinations, to provide useful three-dimensional data and context. To facilitate explanation of the present techniques, however, an airport-type security implementation will be generally discussed herein, though it is to be understood that other security and non-security implementations are also within the scope of the present techniques.

An object of the invention is to provide high performance contraband detection imaging capability for access control of secure areas. Objects to be screened include those where contraband can be concealed inside: handbags, briefcases, backpacks, suitcases, shipping boxes, shipping containers, and the like. Checked bag inspection in the airport as well as checkpoint inspection and cargo inspection are potential applications.

Typical contraband includes, but is not limited to guns, knives, other weapons, explosives, liquids, illegal drugs, currency, radioisotopes, special nuclear materials, and the like, as well as, shielding material that may make the detection of the aforementioned contraband more difficult. The physical geometry of the contraband can take virtually any form including, for example, sheet goods. Sheet goods include objects that are substantially planar in shape or objects that are substantially longer along two axes (i.e., longitudinal axes) than the third axis. Just two examples of sheet goods include sheet plastic explosives, a sheet of metal (e.g., used for shielding), and the like. An objective is to provide a high probability of detection and a low false alarm rate simultaneously. Additional objectives may include fast operation, compact system footprint, acceptable capital and low running costs, ease of use, high reliability, and the like.

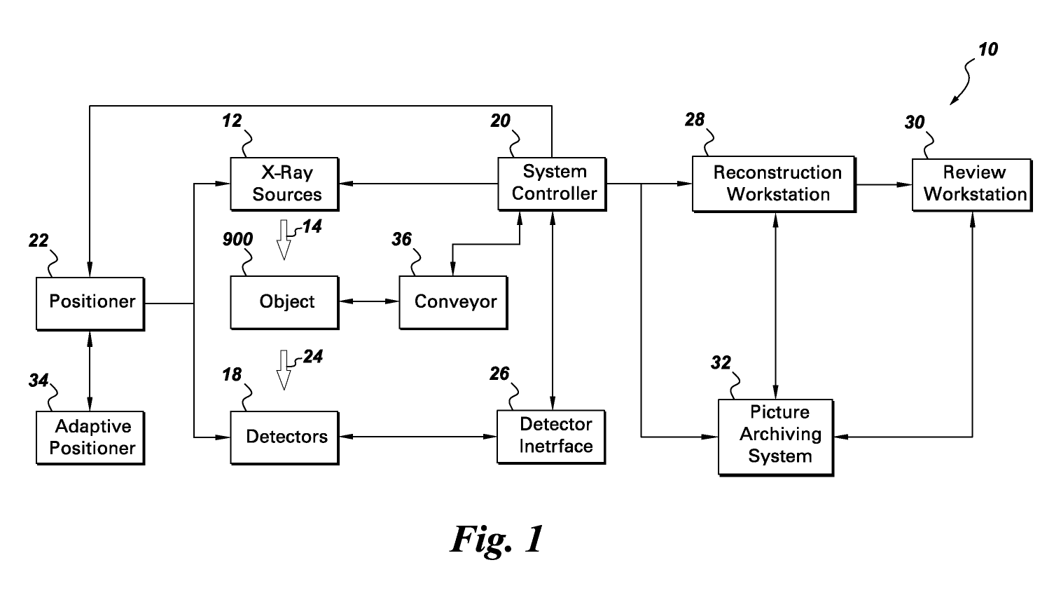

An exemplary multi-view imaging system 10 for use in conjunction with the present method is depicted in FIG. 1 as a block diagram. As depicted the X-ray imaging system 10 may include a plurality of X-ray sources 12, which may comprise a plurality of emission points or producers of X-ray radiation 14. For example, the plurality of X-ray sources 12 may comprise an X-ray tube and generator configured to each generate a beam of X-rays 14 when activated. In addition, the plurality of X-ray sources 12 may be movable in one, two or three dimensions, either by manual or by automated means, such that the position of an emission point may be changed with respect to on object 900 and/or a detector 18. As noted above, the plurality of X-ray sources 12 may include multiple X-ray producing components, such as X-ray tubes, or X-ray emission points, such as field emitters of a solid-state source, disposed at the desired orientations about the object 900. Where the X-ray source 12 includes multiple emission points, the individual activation of the emission points in a desired sequence may functionally equate to the physical movement of an individual emission point relative to the imaged anatomy. Therefore, those of ordinary skill in the art will appreciate that, as discussed herein, moving an X-ray source 12 and/or emission point may be accomplished by the physical movement of an X-ray emitter, by activating two or more such emitters in a sequence that equates to such physical movement, or by some combination of these approaches.

The system 10 includes a plurality of X-ray detectors 18 each configured to detect X-rays emitted 24 by at least one corresponding X-ray source 12 of the plurality of X-ray sources 12 and to generate signals in response to the detected X-rays. In alternative embodiments, more than one detector 18 can be configured to receive X-rays emitted from a single X-ray source 12 (i.e., many-to-one relationship). Similarly, each X-ray source 12 may have only a single corresponding X-ray detector 18 (i.e., one-to-one relationship) from which it received emitted X-rays. In one embodiment, at least one detector 18 receiving X-rays from multiple sources 12, as well as the associated sources 12, may be operated in a multiplexed manner. It should be apparent to one skilled in the art that other variations are possible without departing from aspects of the present invention including, for example, a combination of any of the aforementioned features.

Activation of the plurality of X-ray sources 12 may be controlled by a system controller 20 which may control the activation and operation, including collimation, of the plurality of X-ray sources 12. In particular, the system controller 20 may be configured to provide power and timing signals to the plurality of X-ray sources 12. In addition, the system controller 20 may control the motion of the plurality of X-ray sources 12 and/or the plurality of detectors 18 in accordance with a pre-configured or operator selected imaging trajectory. The system controller 20 may also execute various signal processing and filtration functions, such as for initial adjustment of dynamic ranges, interleaving of digital image data, and so forth. In general, system controller 20 commands operation of the imaging system 10 to execute examination protocols and to acquire the resulting data.

Other elements included in FIG. 1 comprise a positioner 22, system controller 20, detector interface 26, reconstruction workstation 28, review workstation 30, and picture archiving system 3. Exemplary configurations and relationships of these various elements are described in detail in the reference having the common assignee, namely U.S. Pat. No. 7,142,633, filed Mar. 31, 2004, entitled “Enhanced X-ray Imaging System and Method,” the entire contents of which are hereby incorporated by reference.

Returning to FIG. 1, other elements of the system 10 may include an adaptive positioner 34 in communication with positioner 22, which includes the capability to move (e.g., translate, rotate, etc.) a portion of the system 10 in response to obtaining at least partial data from at least one (or more) projection views of the object 900. As will be described in more detail herein, the adaptive positioner 34 capability proves useful, for example in the security environment, with aiding the ability to obtain more accurate image data of the object 900, and in particular with objects that have a sheet-good geometry.

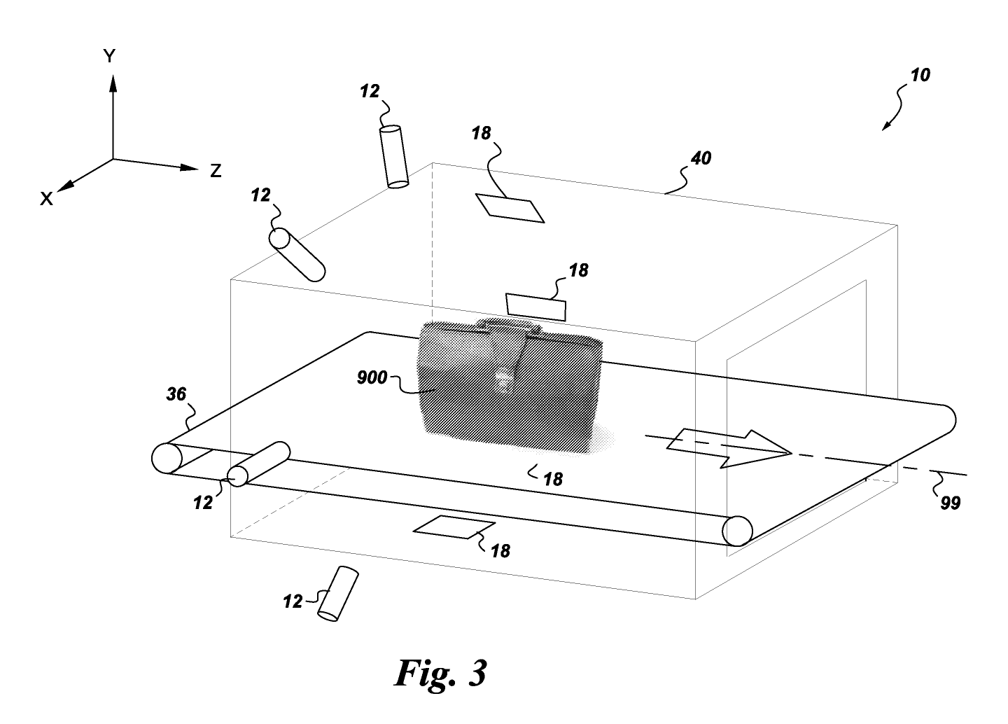

The system 10 may include an object conveyance device, or conveyor 36 that is configured to transport the object 900 along an axis, or path, of travel through an imaging volume 40 (see e.g., FIG. 3) between the plurality of X-ray sources 12 and plurality of detectors 18.

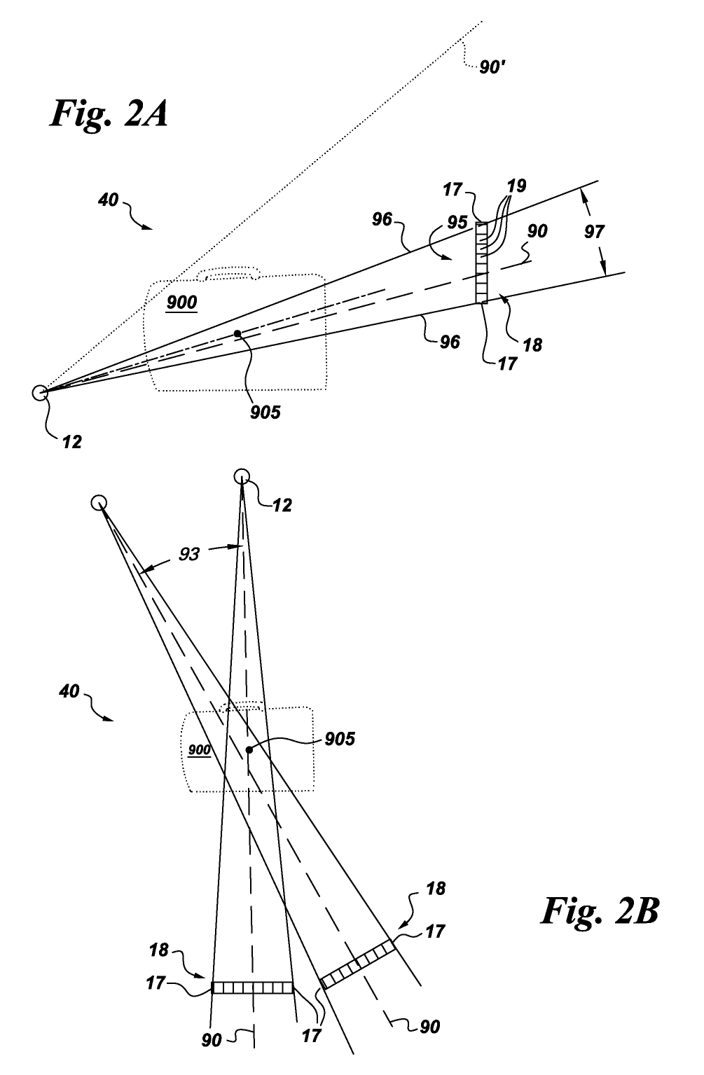

FIG. 2A offers an end view of a portion of an exemplary multi-view imaging system 10, in accordance with the present invention. FIG. 2A illustrates certain definitional aspects. For clarity purposes, only a single X-ray source 12 is shown with a corresponding single X-ray detector 18. In other embodiments discussed herein, multiple X-ray sources may have a single corresponding (receiving) detector. Similarly, in other embodiments, a single X-ray source may have multiple corresponding (receiving) detectors. In any event, as shown, the X-ray source 12 emits X-rays towards a single corresponding detector 18 in a fan shaped beam 95 having a first and a second fan beam edge 96, thereby defining a fan beam angle 97 The fan beam edges 96 may correspond to the ends, or edges, 17 of the detector 18. Various configurations of X-ray source(s) 12 and corresponding detector(s) 18 may be employed, as discussed herein, so as to define different fan beam angles 97. Fan beam angles 97 may vary from, for example, about 10 degrees to about 50 degrees.

At either end of the detector 18 are the detector ends 17. The source 12 and two detector ends 17, being three points in space, thus define a fan beam plane 91. A line that extends from the source 12 through the fan beam plane 91 is defined as a projection direction 90. The projection direction 90 typically extends from the source 12 through the imaging volume 40. Depending on the particular configuration of the system 10, the projection direction 90 does not necessarily extend through the detector 18 and/or the fan beam angle 97, as exemplary projection direction 90′ indicates. For example, in an embodiment where one source 12 corresponds with multiple detectors 18, the calculated projection direction 90 may be defined so that it projects from the source 12 through the fan beam plane 91 but not through either or all detectors 18 corresponding to the source 12 in the system 10. Thus, each system 10 has a plurality of defined projection directions 90 associated therewith the sources 12 and detectors 18. Conceptually, the various projection directions 90 of the system 10 are the various “aiming” axes of the plurality of sources 12 into, and through, the imaging volume 40 and into, and through, any points of interest 905 within the various objects 900 that may travel along the path of travel 99. As discussed herein, under aspects of the present invention the plurality of X-ray sources 12 are located in a predetermined configuration around the imaging volume 40.

Thus, each pair, comprising a detector 18 and a source 12 it receives radiation from, has a corresponding, defined projection direction 90. Referring to FIG. 2B an angular spacing 93 is defined as the angle between two projection directions 90. Depending on the embodiment, the plurality of X-ray sources 12 may, or may not be, coplanar. For example, as FIG. 6 shows, the plurality of X-ray sources 12 and corresponding detectors 18 may be distributed along the path of travel 99 that the object 900 is conveyed and thus not coplanar. As shown in phantom in FIG. 2B, an object 900 (e.g., article of luggage) within the imaging volume 40 may include a point(s), or region, of interest 905. As discussed herein, the object 900 may be conveyed along a path, or axis, of travel 99 (See e.g., FIG. 3), typically by a conveyance device 36. As will be discussed herein, the path or axis of travel 99 may be linear. In other embodiments, the path of travel 99 may be other than linear. For example, the path of travel 99 may be piecewise in that is comprised of multiple linear segments that are, at least partially, non-parallel.

An aspect of the present invention comprises locating the plurality of X-ray sources 12 and detectors 18 around the imaging volume 40 in a predetermined configuration that provides certain advantages over the prior art. The predetermined configuration may include configuring the sources 12 and detectors 18 such that their corresponding projection directions 90 surround the imaging volume 40 by a total angular spacing range of about 180°. In another embodiment, the predetermined configuration may include configuring the sources 12 and detectors 18 such that their corresponding projection directions 90 surround the imaging volume 40 by a total angular spacing range of about 180°−180/Q, wherein Q is a quantity of the plurality of projection directions 90. Thus, for example, in an embodiment, if there are eight (8) total projection directions 90 in a system 10, then the sources 12 and detectors 18 are configured such that the total angular spacing range is about 180°−180/8=180°−22.5°=157.5°. In this manner, it has been discovered that these calculated predetermined configurations offer an enhanced benefit of balancing several of the aforementioned factors resulting an improved multi-view imaging system 10.

In various embodiments of the present invention, the angular spacing 93 (See e.g., FIG. 2B) between adjacent projection directions 90 may be different depending on the quantity of projection directions 90 in the particular system 10. The angular spacing 93 may be no greater than 60°. In another embodiment, the angular spacing 93 may be no greater than 30°. In another embodiment, the angular spacing 93 may be no greater than 10°. In still another embodiment, the angular spacing 93 may be no greater than 5°. The term adjacent, as used herein, with regards to angular spacing does not necessarily mean two X-ray sources 12 and detectors 18 that are physically closest to each other in the system 10. With regard to angular spacing, we can determine two projection directions 90 that define the total angular range of the scan. These two projection directions 90 are substantially opposite, i.e., that are separated by about 180°, or by about 180°−180/Q, wherein Q is a quantity of the plurality of projection directions 90. We can now selected a sequence of projection directions 90 that has those two projection directions 90 as their respective start and end point (of the sequence). Note that the sequence comprises of at least a subset of projection directions 90 defined by the location of sources 12 and detectors 18. The spacing between consecutive projection directions 90 in this sequence defines the angular spacing. In another embodiment, the projection directions 90 corresponding to the start and end points in this sequence are not substantially opposite.

Referring to FIG. 3, a perspective view of an exemplary multi-view imaging system 10, in accordance with the present invention is depicted. The object 900 is transported by an object conveyance device 36 along a path of travel 99. The plurality of X-ray sources 12 at least partially surround an imaging volume 40 in one of the aforementioned predetermined configurations. A plurality of corresponding detectors 18 similarly partially surround the image volume 40 so as to detect X-rays emitted the X-ray source 12 through the object 900. When viewed longitudinally along the Z-axis, the plurality of X-ray sources 12 and their corresponding projection directions 90 (See e.g., FIG. 2) are arranged such that either the angular spacing range around the imaging volume 40 is either about 180° or is about 180°−180/Q, wherein Q is a quantity of the plurality of projection directions 90. Thus, for example in the embodiment shown in FIG. 3, the angular spacing range of the X-ray sources 12 may be about 180° or, an alternative embodiment, about 180°−180/4=180°−45°=135°.

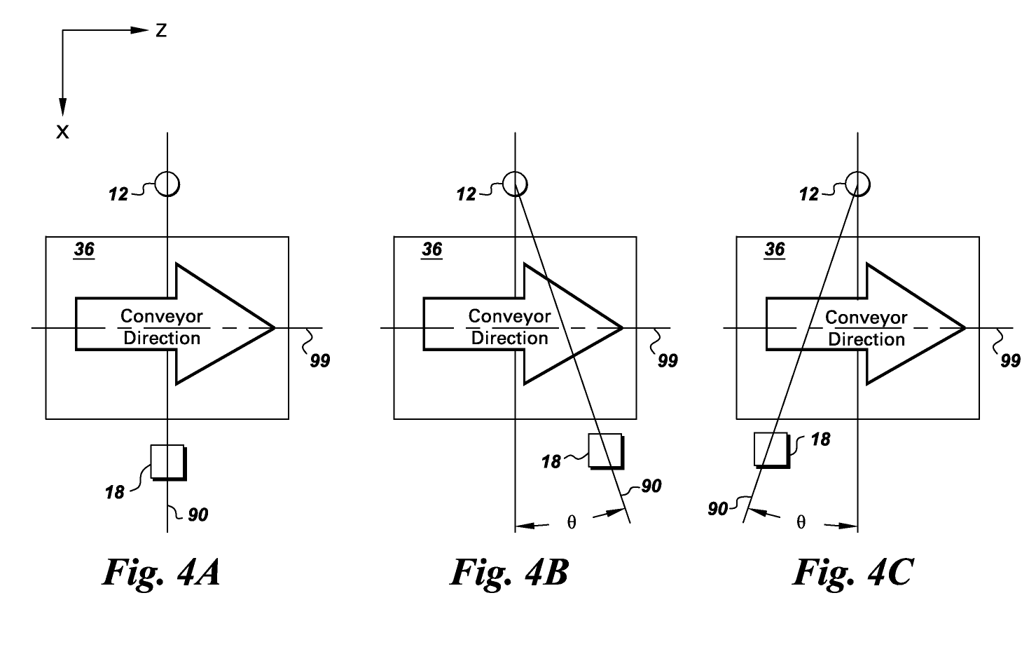

While FIG. 3 depicts an embodiment where all of the plurality of the X-ray sources 12 are substantially coplanar (e.g., sharing an X-Y plane), it should be apparent to one skilled in the art that other variations are possible without departing from aspects of the present invention including, for example, locating the plurality of X-ray sources 12 in a non-coplanar configuration. Referring to FIGS. 4A-4C, different plan views of portions of an exemplary multi-view imaging systems 10, in accordance with the present invention are depicted. As shown, the projection direction 90 defined by the X-ray source 12 and its corresponding X-ray detector 18 may be substantially normal to the path of travel 99 (FIG. 4A). Similarly, the projection direction 90 defined by the X-ray source 12 and its corresponding X-ray detector 18 may be substantially non-normal (e.g., oblique) to the path of travel 99 (FIGS. 4B and 4C). For example, angle theta (A) in FIG. 4B shows how in relation to the path of travel 99 the detector 18 is offset and is “later” along the conveyance device 36 and the path of travel 99 from its corresponding X-ray source 12. Similarly, angle theta (A) in FIG. 4C shows how in relation to the conveyance device 36 and the path of travel 99 the detector 18 is offset and is “earlier” in the path of travel 99 from its corresponding X-ray source 12. In this manner, the defined projection directions 90 of each configuration may be substantially normal (see e.g., FIG. 4A) to the path of travel 99 or substantially not normal (offset or oblique) (see e.g., FIGS. 4B and 4C) to the path of travel 99 when viewed along the Y-axis.

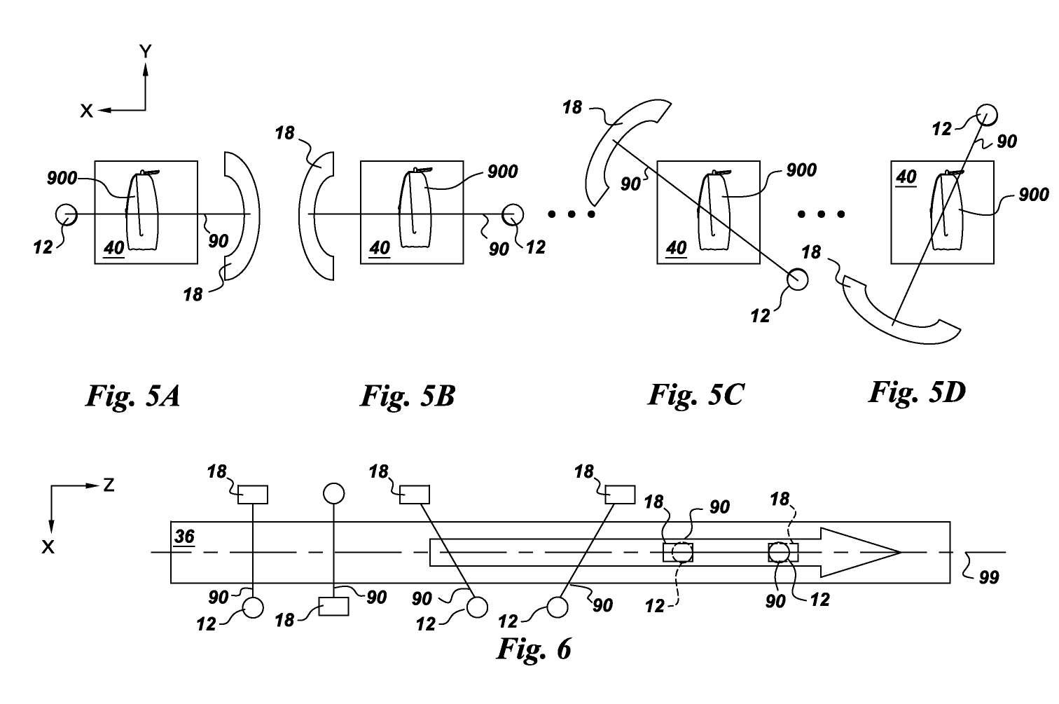

Just as FIGS. 4A-4C depict exemplary embodiments that show the defined projection direction 90 may have various and different rotations about the Y-axis, the projection direction 90 defined by X-ray source 12 and detector 18 may similarly be rotated about the Z-axis in various embodiments. Referring to FIGS. 5A-5D end views of portions of other exemplary multi-view imaging systems 10 in accordance with the present invention, are depicted. Viewing the systems 10 along the Z-axis, the defined projection direction 90 between X-ray source 12 and detector 18 may be parallel to the conveyance device surface 36 (see e.g., FIGS. 5A, 5B). Similarly, the defined projection direction 90 between X-ray source 12 and detector 18 may be normal to the conveyance device surface 36 (not shown). In other embodiments, the defined projection direction 90 between X-ray source 12 and detector 18 may be neither normal nor parallel (e.g., angled, offset, oblique, etc.) to the conveyance device surface 36 (see e.g., FIGS. 5C, 5D). It should be apparent to one skilled in the art that other variations are possible without departing from aspects of the present invention including, for example, a combination of the aforementioned features. For example, one or more X-ray source 12 and detector 18 pairs may be configured so that the defined projection direction 90 may be both, neither normal to the z-axis and neither parallel nor normal to the conveyance device surface 36 (e.g., skewed).

Since the object 900 under inspection moves past the sources 12 and detectors 18 on a conveyor, the placement of the sources 12 and detectors 18 may be flexible. As the quantity of projection directions 90 increases, it may become difficult to locate all the x-ray sources 12 around the object 900 (e.g., bag) in a common, or shared, plane at the same distance down the conveyor belt 36. Hence, in an embodiment a source(s) 12 with its associated detector(s) 18 can be positioned at virtually any distance along the belt 36, as shown in FIG. 6. Various configurations may be advantageous in a particular situation, from all sources 12 (and associated detector(s) 18) in the same plane (along the conveyor belt), to each source(s) 12 (and associated detector(s) 18) in a different plane. While spreading the sources 12 and detectors 18 along the belt 36 may increase the footprint of the system 10 to a degree, it has only minimal impact on the inspection time, since inspection time is related to the time it takes the object 900 to translate down the belt through the system 10. Similarly, the position of each source 12/detector 18 pair (or more general configuration) may generally be switched without a significant impact on the information contained in the collected data. For example, instead of locating a source 12 underneath the conveyor 36 and a set of associated detectors 18 above the imaging volume 40 (e.g., bag tunnel), the source 12 may be placed above the tunnel, and the detectors 18 underneath the conveyor 36. By modifying configurations in this way, the system footprint as well as the interaction between beamlines (e.g., due to scatter) may be optimized.

Referring to FIG. 6, a plan view of an exemplary multi-view imaging system 10, in accordance with the present invention, is depicted. As shown, the plurality of X-ray sources 12 and detectors 18 with their corresponding defined projection directions 90 may be distributed along the path of travel 99 or conveyor 36. The sequence of source 12 and detector 18 configurations along path of travel 99 may vary depending on the particular embodiment. For example, as shown the first two source/detector pairs (e.g., two beam lines furthest to left in FIG. 6) may be interleaved so that the source 12 at the second source 12/detector 18 pair (second beam line) is configured to be substantially towards an opposite side of the imaging volume 40, with respect to the Z-axis, as the immediately previous source 12/detector 18 pair (first beam line). In this manner, image data obtained from the object 900 (e.g., suitcase) at the beginning (e.g., from first and second beamlines) of the travelpath through the system 10 along the conveyor 36 is maximized. Note that in FIG. 6 it appears that the first two beamline pairs along the travelpath 99 and the last two beamline pairs of the travelpath 99 may be opposite (e.g., 180 degrees apart) or nearly opposite (e.g., about 170 degrees apart) from each other. Although an embodiment may have this configuration, a more preferable embodiment comprises the first successive source 12/detector 18 pairs configured so that they have beamlines 90 that are, for example, about 90 degree offset from each other. In this manner, information obtained by the first two source/detector pairs of the system is maximized. In this manner, having beam lines 90 that are approximately 180 degrees apart would provide substantially redundant data, and thus, not entirely necessary. It should be apparent to one skilled in the art that other variations are possible without departing from aspects of the present invention including, for example, a combination of any of the aforementioned features. For example, each source 12 detector 18 pair and their defined projection directions 90 along the conveyor 36 could have different orientations with regards to the axis of travel 99. Note that the projection directions 90 are generally considered relative to a point in the object of interest 900, as it passes through the respective beams of X-ray radiation. If, for example, the detector size is not sufficient to capture X-ray data of the full object, multiple source/detector pairs may be used to achieve the substantially same projection direction 90 relative to different locations within the imaged object 900. It should be apparent to one skilled in the art that even when the detector size is not sufficient to cover the full object, different configurations may be used as well that allow to have a maximum angular spacing between projection directions at multiple reference points within the image object/volume, without duplicating the same projection direction with multiple source/detector pairs.

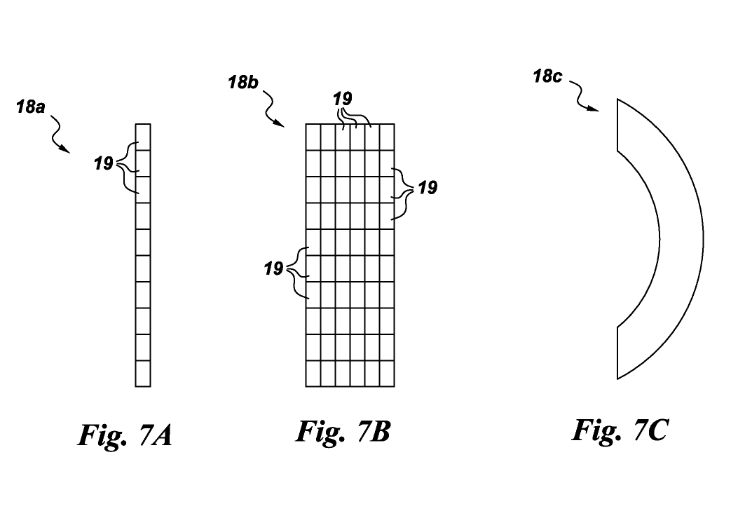

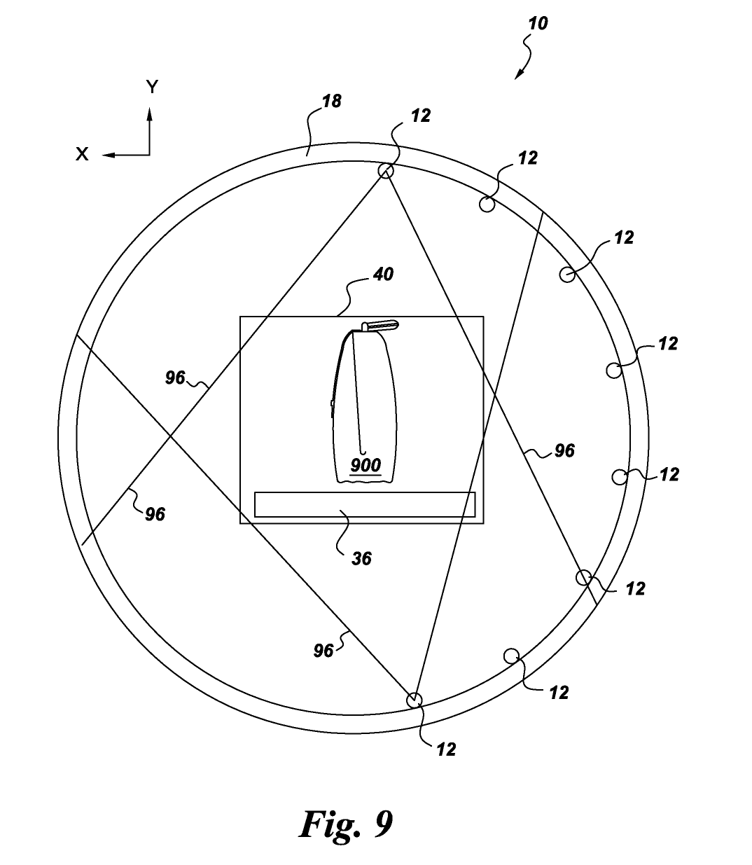

Referring to FIGS. 7A-7C, exemplary types of detectors 18 which may be employed under aspects of the present invention, are depicted. For example, a single row array (FIG. 7A) detector 18A may be used. Similarly, a multi-dimensional array (FIG. 7B) or a L-shaped detector (not shown) may be used. The detector 18 may be arcuate in shape (See FIG. 7C). In another embodiment, the detector 18 may comprise an annular ring (see e.g., FIG. 9), or other geometry (e.g., square, polygonal, asymmetrical, etc.) configuration to entirely surround the imaging area 40. In another embodiment, the detector 18 may comprise a semi-annular ring configuration to partially surround the imaging area 40. It should be apparent to one skilled in the art that other variations are possible without departing from aspects of the present invention including, for example, a system 10 that includes a combination of any of the aforementioned features.

Various types of sources 12 and detectors 18 may be used under aspects of the present invention. For example, the system 10 may be configured to operate at multiple X-ray energies. Similarly, the sources 12 may be configured so that at least two of the X-ray sources 12 emit different spectra energy. Alternatively, the sources 12 may be configured so that at least one of the X-ray sources 12 emits at least two different energy spectra. In another embodiment, at least one of the detectors 18 may comprise an energy sensitive detector.

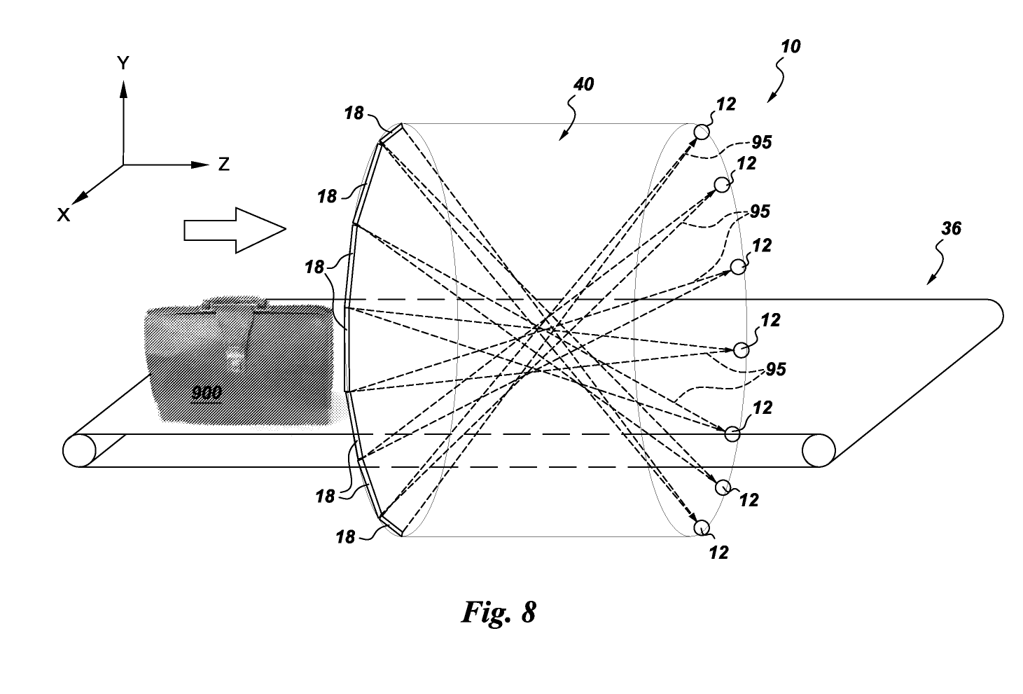

Referring to FIG. 8, a side perspective view of another exemplary multi-view imaging system 10, in accordance with the present invention, is depicted. As shown in this embodiment, the plurality of X-ray sources 12 is substantially coplanar and the plurality of detectors 18 is also substantially coplanar. The two planes each defined by the respective plurality of X-ray sources 12 and detectors 18 are parallel but do not share the same plane to each other and are substantially normal to the path of travel 99. In other embodiments, the planes (i.e., of sources 12 and detectors 18) may be non-parallel and/or not normal to the path of travel 99. Similarly, only the sources 12 may be coplanar, while the detectors 18 are not all coplanar; and, the detectors 18 may be coplanar, while the sources 12 are not all coplanar. In another embodiment, additional source/detector pairs may be added to this configuration such as to achieve a sequence of projection directions 90 with a total angular range more closely approximating 180°. For example, more detector (not shown) can be added below the conveyor, receiving X-rays form the top-most X-ray source, such that the additional detectors cover the angular range of projection directions from the one associated with the top-most detector and the bottom-most detector, to the one substantially opposite to the projection direction associated with the bottom-most x-ray source and the top-most detector. Each of the source/detector pairs may also be offset in the x-direction. It should be apparent to one skilled in the art that other variations are possible without departing from aspects of the present invention including, for example, a combination of any of the aforementioned features.

Referring to FIG. 9, an end view of an exemplary multi-view imaging system, in accordance with the present invention, is depicted. This particular embodiment may eliminate the need for a separate detector for each source. A ring-shaped or annular-type detector 18 is employed that entirely surrounds the inspection area 40. X-ray sources 12 may be fired sequentially (in rapid succession so that object 900 movement down the conveyor 36 between two “shots” is not too great) and just the section of the detector 18 intersected by the x-ray beam for that source 12 position is read out. As shown in FIG. 9, for sources 12 arranged over part of the circle, only a portion of the entire detector 18 is used, enabling additional cost savings associated with not populating that portion of the detector 18. Alternately, a single detector 18 may be used to acquire data from more than one x-ray source 12, using multiplexing to uniquely link a detector 18 to a particular source 12 at a particular time.

If space to position the x-ray tubes 12 is an issue, the sources 12 may be arrayed around the entire circle with twice the angular spacing. For example, if eighteen (18) sources are employed, instead of one source every 10° from 0°-170°, the sources could be spaced at 20° increments over the first ½ circle (0, 20, . . . 160) and then in additional 20° increments from 190 to 350° to ease positioning concerns. This type of configuration reflects the earlier observation that the relative position of tube 12 and detectors 18 can be switched. Generally, it may also be advantageous to have specific source/detector pairs that are aligned with the expected position of the sides of a screened object.

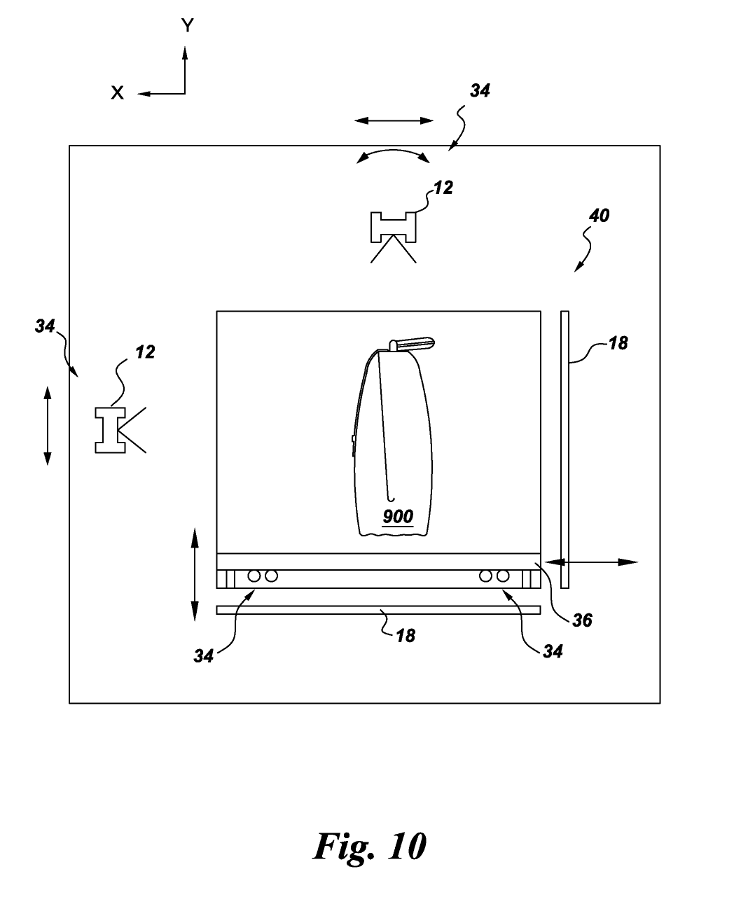

Referring to FIG. 10, an end view of an exemplary multi-view imaging system including an adaptive positioning device 34, in accordance with the present invention, is depicted. Consider a case where N source positions are used, distributed over approximately 180 degrees. In this case, the angular separation between source 12 positions is Δθ=180/N. For N=18, Δθ=10 degrees. For the detection of items having a geometry with certain high aspect ratio objects (e.g., sheet goods), it may be advantageous to align a source position with a “long”, or longitudinal, direction of the object, or at least, to minimize the offset between the source 12 position and the “long” axis. In this case, position and orientation information derived from the first N images (e.g., for N=2, and the first two sources 12 aligned at 0 and 90 degrees) could be used to activate the adaptive positioning device 34 so as, for example, to tilt the conveyor belt 36 by, for example, 5° to obtain an improved alignment of a source 12 position with the “long” axis of the high aspect ratio object 900. Exemplary actuators that can tilt the conveyor 36 by a small angle are shown in FIG. 10. Similarly, the object 900 position may be tilted/rotated around an axis that is orthogonal to the belt position. A simple translation of the bag (e.g., a lateral translation) may be used to accomplish the same goal. Alternatively, the position of system components (sources and/or detectors) may be adapted to enable acquisition of “in-between” views. In another embodiment, dedicated system components may be used for the in-between views. In general, a multi-pass inspection may be used, where the bag is passed through the system 10 more than once, with some acquisition parameter(s) modified for each scan. In one embodiment, multiple passes through the system may be accomplished by simply reverting the direction of the conveyor device 36. The new parameter values may (or may not) be chosen based on information derived from earlier passes.

Based on geometric considerations as discussed herein, it is unlikely that sources 12 distributed over a range of angular positions greater than 180° would be useful, since the data acquired over the remaining 180° is largely redundant with the data acquired over the first 180°. In an embodiment of the source positions for this invention is N source positions distributed in angle from 0 degrees to (180−Δθ), in increments of Δθ, where Δθ=180/N. For example, if N=18, then Δθ=10 degrees, and the sources are distributed from 0 to 170 degrees in 10 degree increments, as shown in FIG. 8

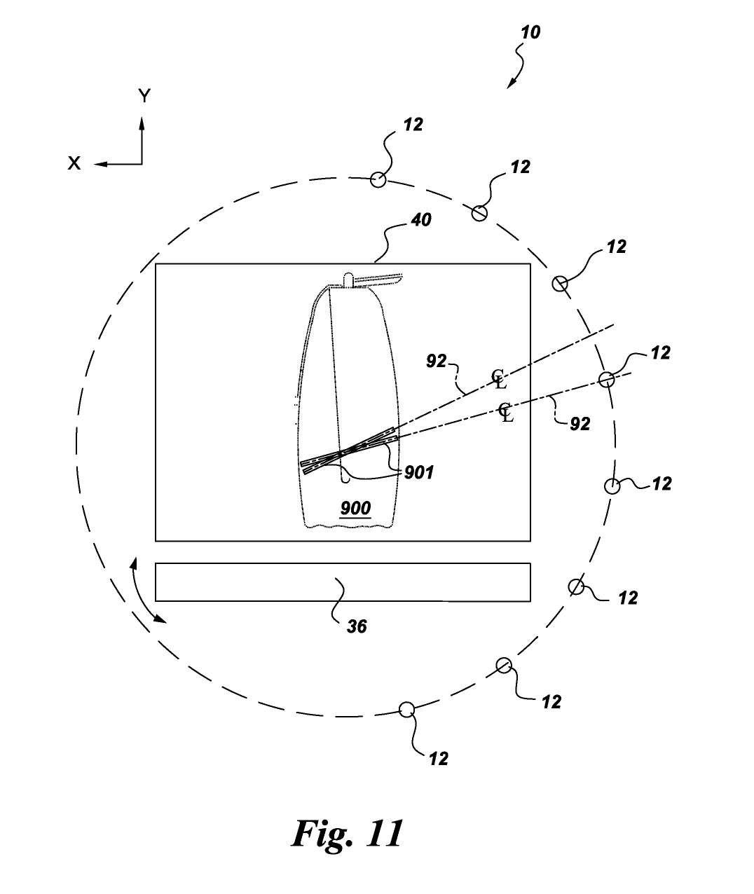

As shown in FIG. 11 the object 900 (e.g., suitcase) being scanned includes an item of interest 901 having a sheet-good type geometry. The sheet good 901 by definition has at least one longitudinal axis, or centerline, 92. As depicted, the system 10 employs an adaptive positioning device 34 (see e.g., FIG. 10) that is configured to translate and/or rotate at least one of the X-ray source 12, detector 18, and/or the object support in response to obtaining at least partial data from at least a first projection view of the object 900. In this manner, after at least partial data from at least a first projection view of the object 90 is obtained, the adaptive positioning device 34 is able to move at least one of the aforementioned elements so that at least one source 12 more closely aligns its respective beam line 98 with the longitudinal axis 92 of the sheet good 901. As a result, image data of the sheet good 901 is improved.

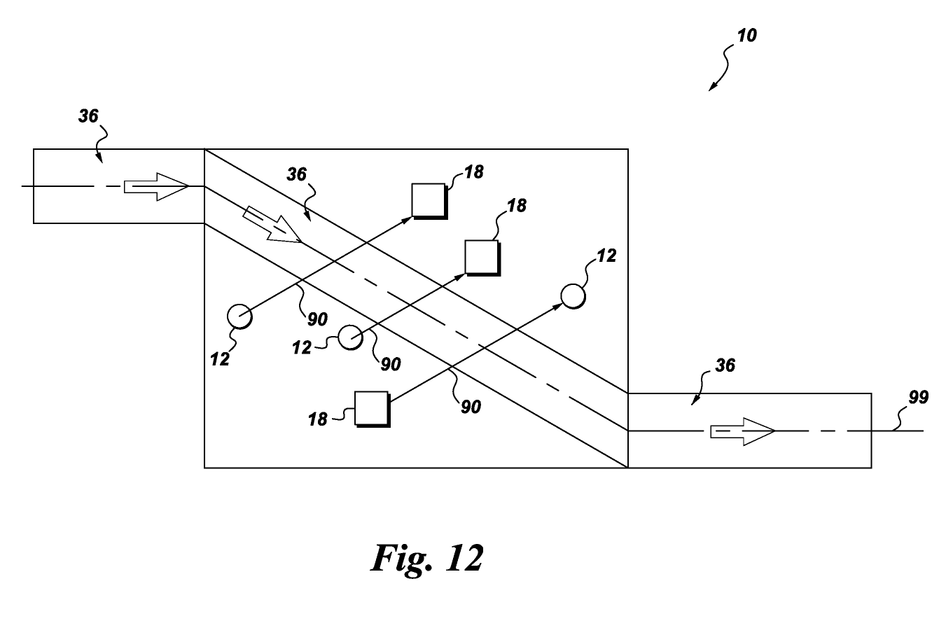

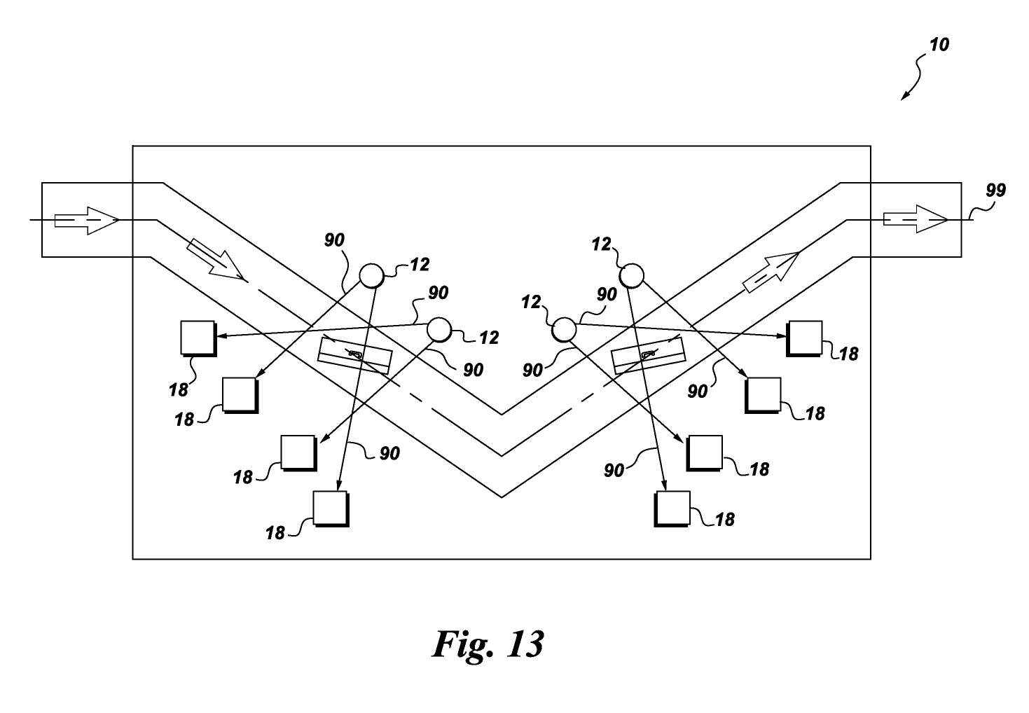

Referring to FIGS. 12 and 13, plan views of two other exemplary multi-view imaging systems 10, in accordance with the present invention, are disclosed. Additional data acquisition configurations can be implemented by novel conveyor trajectories. The “conveyor zig” configuration depicted in FIG. 12 provides an improved overall system footprint. If, for example, a CT-like tomo acquisition configuration is used, the components (e.g., 12, 18) associated with the projection directions 90 may be arranged on both sides of the conveyor 36. By offsetting the components (e.g., 12, 18) along the length of the conveyor 36, the total system width can be lessened by adjusting the conveyor trajectory.

Similarly, a slightly more complicated “conveyor zig-zag” configuration depicted in FIG. 13 enables acquiring views of the object 900 from a full 180 degrees (or more) without repeat rotated source/detector pairs. This type of approach “trades” off the number of tube/detector components against increased complexity in the bag handling mechanism. If a 3D reconstruction from the acquired view is desired, the bag handling mechanism has to be accurate (e.g., using bins to transport the bags), and/or the position has to be calibrated (e.g., using markers in the bins), etc. Note that the “zig-zag” conveyor configuration can be arranged horizontally and/or vertically (e.g., including a vertical motion component) in other embodiments. A portion of, or the entire, path of travel 99 may be non-linear. Alternatively, the path of travel 99 may be piecewise linear wherein the path is comprised of multiple non-parallel and/or non-coaxial linear segments. It should be apparent to one skilled in the art that other configurations of path of travel 99 are available without departing from the present invention including combinations of the various aforementioned embodiments.

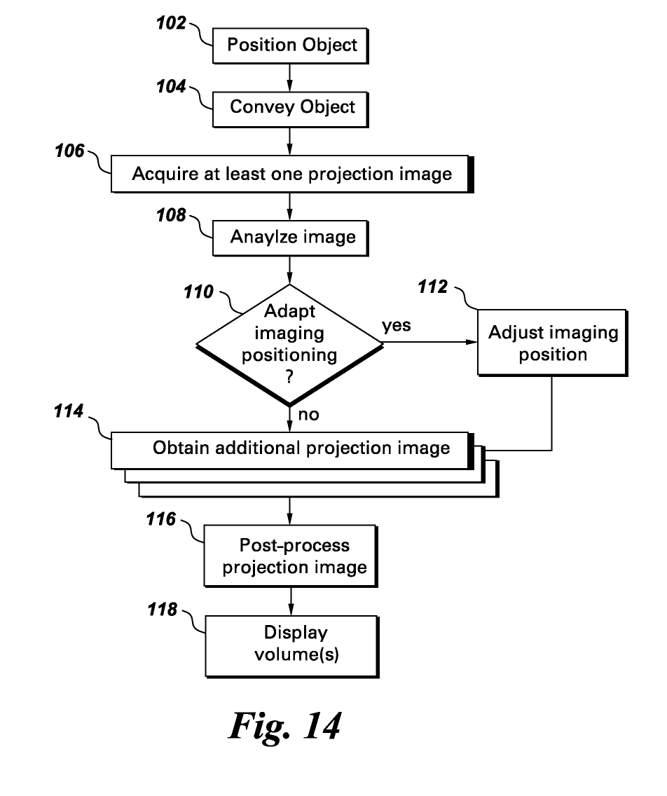

Referring to FIG. 14, a flow chart of a method of multi-view imaging, in accordance with the present invention, is depicted. At 102, an object 900 is positioned on a conveyance device 36. The object 900 is conveyed along the conveyance device 36 at 104. The system 10 then acquires at least one projection image of a portion of the, or the entire, object 900 at 106. The image is analyzed at 108. At 110, a determination is made if any imaging positioning adjustment(s) are required. If adjustments are required (i.e., “Yes” at 110), then the imaging position is adjusted at 112. Regardless if adjustments are made (i.e., 112), additional projection images are obtained at 114. Then at 116, projection images are post processed. Various volume(s) are displayed at 118.

It should be noted that embodiments of the invention are not limited to any particular computer for performing the processing tasks of the invention. The term “computer,” as that term is used herein, is intended to denote any machine capable of performing the calculations, or computations, necessary to perform the tasks of the invention. The term “computer” is intended to denote any machine that is capable of accepting a structured input and of processing the input in accordance with prescribed rules to produce an output. It should also be noted that the phrase “configured to” as used herein means that the computer is equipped with a combination of hardware and software for performing the tasks of the invention, as will be understood by those skilled in the art.

The various embodiments of a multi-view imaging system and method described herein thus provide a way to provide high performance contraband detection imaging capability for access control of secure areas. Further, the system and method allows for a cost-effective means of providing a higher probability of detection coupled with a low false alarm rate as well as fast operation, a compact system footprint, adequate capital and low running costs, ease of use, and/or high reliability.

Therefore, according to one embodiment of the present invention, a multi-view imaging system, comprises: a plurality of X-ray sources, each X-ray source configured to emit X-rays, wherein each X-ray source emits X-rays in a fan-shaped beam each having a first and a second beam edge defining a fan beam angle, wherein the plurality of X-ray sources are located in a predetermined configuration around an imaging volume; a system controller configured to operate the plurality of X-ray sources; a plurality of detectors, each detector configured to detect X-rays, each detector configured to generate signals in response to the detected X-rays, wherein each of the plurality of X-ray sources are configured to emit X-rays to at least one of the plurality of detectors, further wherein the X-ray source and two end points of a corresponding detector define a fan beam plane, further wherein a line extending from the X-ray source within the fan beam plane and through the imaging volume defines a projection direction, wherein adjacent projection directions define an angular spacing; an object conveyance device configured for transporting an object along a path of travel through the imaging volume between the plurality of X-ray sources and the plurality of detectors; and a detector interface configured to acquire the signals from the plurality of detectors, wherein the predetermined configuration is defined wherein one of: the plurality of projection directions when viewed along a longitudinal axis of the image system surround the imaging volume by an angular range of about 180 degrees; and the plurality of projection directions when viewed along a longitudinal axis of the image system surround the imaging volume by an angular range of about 180°−180/Q, wherein Q is a quantity of the plurality of projection directions.

According to another embodiment of the present invention, a multi-view imaging system, comprises: a plurality of X-ray sources, each X-ray source configured to emit X-rays in a fan-shaped beam having a first and a second beam edge defining a fan beam angle, wherein the plurality of X-ray sources are located in a predetermined pattern around an imaging volume; a system controller configured to operate the plurality of X-ray sources; a plurality of detectors, each configured to detect X-rays emitted by at least one of the plurality of X-ray sources and to generate signals in response to the detected X-rays, wherein an X-ray source and two end points of a corresponding detector define a fan beam plane, further wherein a line extending from the X-ray source through the fan beam plane defines a projection direction, wherein adjacent projection direction define an angular spacing; an object conveyance device configured for transporting an object along a path of travel through the imaging area between the plurality of X-ray sources and the plurality of detectors; and a detector interface configured to acquire the signals from the plurality of detectors, wherein the predetermined pattern is defined wherein one of: the plurality of projection directions surround the imaging volume by an angular range of about 180 degrees, and the plurality of projection directions surround the imaging volume by an angular range of about 180°−180/Q, wherein Q is a quantity of the plurality of projection directions.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A multi-view imaging system, comprising:
a plurality of X-ray sources, each X-ray source configured to emit X-rays, wherein each X-ray source emits X-rays in a fan-shaped beam each having a first and a second beam edge defining a fan beam angle, wherein the plurality of X-ray sources are located in a predetermined configuration around an imaging volume;
a system controller configured to operate the plurality of X-ray sources;
a plurality of detectors, each detector configured to detect X-rays, each detector configured to generate signals in response to the detected X-rays, wherein each of the plurality of X-ray sources are configured to emit X-rays to at least one of the plurality of detectors, further wherein the X-ray source and two end points of a corresponding detector define a fan beam plane, further wherein a line extending from the X-ray source within the fan beam plane and through the imaging volume defines a projection direction, wherein adjacent projection directions define an angular spacing;
an object conveyance device configured for transporting an object along a path of travel through the imaging volume between the plurality of X-ray sources and the plurality of detectors; and
a detector interface configured to acquire the signals from the plurality of detectors, wherein the predetermined configuration is defined wherein one of:
the plurality of projection directions when viewed along a longitudinal axis of the image system surround the imaging volume by an angular range of about 180 degrees; and
the plurality of projection directions when viewed along a longitudinal axis of the image system surround the imaging volume by an angular range of about 180°−180/Q, wherein Q is a quantity of the plurality of projection directions.

2. The multi-view imaging system of claim 1, wherein the angular spacing is no greater than about 60 degrees.

3. The multi-view imaging system of claim 2, wherein the angular spacing is no greater than about 30 degrees.

4. The multi-view imaging system of claim 3, wherein the angular spacing is no greater than about 10 degrees.

5. The multi-view imaging system of claim 4, wherein the angular spacing is no greater than about 5 degrees.

6. The multi-view imaging system of claim 1, wherein the plurality of projection directions are substantially coplanar.

7. The multi-view imaging system of claim 1, wherein the plurality of X-ray sources and the plurality of detectors are arranged such that the fan-beam planes are substantially coplanar.

8. The multi-view imaging system of claim 1, wherein at least one of the plurality of projection directions is oblique to the path of travel.

9. The multi-view imaging system of claim 1, wherein at least one of the detectors is configured to receive X-ray beams from a plurality of X-ray sources.

10. The multi-view imaging system of claim 1, wherein at least one of the plurality of X-ray sources is configured to emit X-rays towards two or more of the plurality of detectors; and
the plurality of X-ray sources each emit X-rays in one or more fan-shaped beams each having a first and a second beam edge defining a fan beam angle, thereby defining a plurality of fan beam angle, further defining a plurality of fan beam planes.

11. The multi-view imaging system of claim 1, wherein at least one of the plurality of projection directions is within the fan beam angle.

12. The multi-view imaging system of claim 1, wherein the object comprises a sheet good.

13. The multi-view imaging system of claim 1, wherein the object comprises one of an article of luggage, a liquid, contraband, explosives, drugs, nuclear material, and shielding material.

14. The multi-view imaging system of claim 1, wherein a portion of the path of travel is non-linear.

15. The multi-view imaging system of claim 1, wherein the path of travel is piecewise linear comprising a plurality of non-parallel linear segments.

16. The multi-view imaging system of claim 1, wherein an orientation of the object remains substantially constant during imaging.

17. The multi-view imaging system of claim 1, the object conveyance device comprising an object support; and
further comprising an adaptive positioning device to translate or rotate at least one of:
at least one of the plurality of X-ray sources, at least one of the plurality of detectors, and the object support in response to obtaining at least partial data from at least a first projection view of the object.

18. The multi-view imaging system of claim 16, wherein the object is a sheet good.

19. The multi-view imaging system of claim 18, wherein the translation or rotation is made in response to acquiring a projection view substantially along at least one longitudinal axis of the sheet good.

20. The multi-view imaging system of claim 1, wherein the imaging system is configured to operate at multiple X-ray energies.

21. The multi-view imaging system of claim 20, wherein at least two of the plurality of X-ray sources emit different spectra energy.

22. The multi-view imaging system of claim 20, wherein at least one of the plurality of detectors comprises an energy sensitive detector.

23. The imaging system of claim 20, wherein at least one of the plurality of X-ray sources is configured to emit at least two different energy spectra.

24. The multi-view imaging system of claim 1, wherein one of the plurality of detectors is an array or arcuate.

25. The multi-view imaging system of claim 1, wherein the plurality of projection directions are not coplanar.

26. The multi-view imaging system of claim 1, wherein the plurality of projection directions are substantially orthogonal to the path of travel and not coplanar.

27. A multi-view imaging system, comprising:
a plurality of X-ray sources, each X-ray source configured to emit X-rays in a fan-shaped beam having a first and a second beam edge defining a fan beam angle, wherein the plurality of X-ray sources are located in a predetermined pattern around an imaging volume;
a system controller configured to operate the plurality of X-ray sources;
a plurality of detectors, each configured to detect X-rays emitted by at least one of the plurality of X-ray sources and to generate signals in response to the detected X-rays, wherein an X-ray source and two end points of a corresponding detector define a fan beam plane, further wherein a line extending from the X-ray source through the fan beam plane defines a projection direction, wherein adjacent projection direction define an angular spacing;
an object conveyance device configured for transporting an object along a path of travel through the imaging area between the plurality of X-ray sources and the plurality of detectors; and
a detector interface configured to acquire the signals from the plurality of detectors, wherein the predetermined pattern is defined wherein one of:
the plurality of projection directions surround the imaging volume by an angular range of about 180 degrees, and
the plurality of projection directions surround the imaging volume by an angular range of about 180°−180/Q, wherein Q is a quantity of the plurality of projection directions.

28. The multi-view imaging system of claim 27, wherein the angular spacing is no greater than about 60 degrees.

29. The multi-view imaging system of claim 28, wherein the angular spacing is no greater than about 30 degrees.

30. The multi-view imaging system of claim 29, wherein the angular spacing is no greater than about 10 degrees.

31. The multi-view imaging system of claim 30, wherein the angular spacing is no greater than about 5 degrees.

32. The multi-view imaging system of claim 27, wherein the plurality of projection directions are not coplanar.
